(19) United States
(12) Patent Application Publication
(10) Pub. No.: US 2024/0416583 A1
(43) Pub. Date: Dec. 19, 2024

(54) METHODS, APPARATUS, COMPOSITIONS OF MATTER, AND ARTICLES OF MANUFACTURE RELATED TO ADDITIVE MANUFACTURING OF POLYMERS

(71) Applicant: Massachusetts Institute of Technology, Cambridge, MA (US)

(72) Inventors: Cecile A. C. CHAZOT, Cambridge, MA (US); Megan A. CREIGHTON, Wallingford, PA (US); Anastasios John HART, Waban, MA (US)

(21) Appl. No.: 18/689,860

(22) PCT Filed: Nov. 7, 2022
(86) PCT No.: PCT/US2022/049136

§ 371 Date: Mar. 6, 2024

Related U.S. Application Data
(60) Provisional application No. 63/276,299, filed on Nov. 5, 2021.

(51) Int. Cl. B29C 64/124; B29C 64/264; B29C 64/336; B29K 101/10; B29K 101/12; B33Y 10/00; B33Y 40/00; B33Y 70/00; C08F 2/16; C08F 2/50; C08F 20/44

(52) U.S. Cl. CPC B29C 64/124; B29C 64/264; B29C 64/336; C08F 2/16; C08F 2/50; C08F 20/44; B29K 2101/10; B29K 2101/12; B33Y 10/00; B33Y 40/00; B33Y 70/00

(57) ABSTRACT

Systems, methods, and compositions for using Interfacial Photopolymerization (IPP) for high-resolution digital processing of polymers are disclosed. In IPP, a polymer film can be formed at an interface between two liquids, each containing a species involved in a polymerization reaction. The two liquids can include a photoinitiator and a monomer that are immiscible and/or reactive such that the film can form at the interface. The polymerization reaction can be controlled by a LED light source, which is focused at a reaction zone located at or near the liquid-liquid interface. The resulting polymer results in a high-resolution, high-throughput AM of thermoplastic polymers that enables on-demand production of objects that exhibit exceptional dimensional quality, mechanical properties, and recyclability characteristics.

### CROSS REFERENCE TO RELATED APPLICATION

The present disclosure claims priority to and the benefit of U.S. Provisional Application No. 63/276,299, entitled “Methods, Apparatus, Compositions of Matter, and Articles of Manufacture Related to Additive Manufacturing of Polymers,” filed on Nov. 5, 2021, the content of which is incorporated by reference herein in its entirety.

### FIELD

The present disclosure relates to systems, methods, and compositions of matter of using interfacial photopolymerization to print linear chain polymers, and more particularly relates to a systems, methods, and compositions for additive manufacturing thermoplastic polymers using spatial control of a photopolymerization reaction between two immiscible liquids.

### BACKGROUND

Polymers are widely used in products due to their low cost and desirable material properties. In recent years, however, there is increasing concern about the quantity and fate of plastics in the environment. Globally, there are 6.3 billion metric tons of plastic waste, and the amount is growing at an increasing rate. Therefore, there is currently a growing demand for greener and more sustainable products that incorporate advanced materials and enable higher end use value. Billions of dollars annually are being invested in research and development efforts worldwide to discover materials, manufacturing processes, and life-cycle approaches that reduce the consumption and disposal of plastics that are seen as vital to sustainability efforts. To meet the global need, interest in additive manufacturing (AM) has increased in recent years due to its speed and scalability. There are strong business incentives for adoption of AM because it can shorten product time to market by making parts directly without dedicated capital equipment or tools while also enabling mass production with reduced lead time. AM can also enable rapid design iteration and on-demand production of service components.

AM has several shortcomings, particularly with respect to sustainability, as will be recognized by one skilled in the art. One such example is that AM commonly exhibits low productivity rates, which may mean that the energy cost per unit is higher when compared to conventional manufacturing methods, especially if the AM process is slow and requires elevated temperatures.

AM that uses photopolymerization, such as stereolithography (SLA) and Digital Light Processing (DLP), is widely adopted due to its high resolution, simplicity, and the broad range of mechanical properties available from photopolymer resins. However, the technique is currently restricted to cross-linked polymers, resulting in challenges in both post-processing and recycling of printed parts that are absent when considering thermoplastic AM techniques. For example, these photopolymerization AM methods can produce parts with superior surface finish and detail relative to the methods available for thermoplastics, but these attributes come at the expense of, for example, compatibility with large-scale recycling processes.

Accordingly, there is a need for developing systems and processes for using thermoplastics in AM to make objects that are compatible with a variety of polymers.

### SUMMARY

The present application is directed to systems and methods for using Interfacial Photopolymerization (IPP) for high-resolution digital processing of polymer systems. IPP can reduce the prevalence of non-recyclable photopolymers in AM by enabling photopolymerization of widely desirable thermoplastics. IPP can also avoid key challenges associated high-temperature processing of thermoplastics by extrusion-based or laser-based AM methods, such as anisotropy of mechanical properties, and residual stress induced during cooling that can cause warping or interlayer delamination. Polymer systems that can be processed via IPP can include polystyrene (PS) and polymethyl methacrylate (PMMA), commodity polymers widely used in industrial and consumer products, and polyacrylonitrile (PAN), which is difficult to form by both conventional processing and other AM techniques.

IPP enables photopolymerization AM of linear chain polymers or thermoplastics. In IPP, a polymer film can be formed at an interface between two immiscible reactive liquids, each containing a species involved in a polymerization reaction that occurs at the interface. In some embodiments of IPP, one of the immiscible phases contains a photoinitiator, while the other contains a monomer or prepolymer. The monomer can be an organic monomer and the photoinitiator can be water soluble. In IPP, the polymerization process and resolution can be controlled by an LED light source, which can be focused at a reaction zone located at or near a planar liquid-liquid interface. A location of the liquid-liquid interface and the reaction zone can be controlled by a control loop that controls one or more parameters of the photopolymerization reaction that forms the polymer film. For example, polymer film formation can be optimized and/or customized based on fundamental transport and reaction kinetics, light management conditions, and/or chemical thermodynamics to elucidate the governing physical mechanisms for polymer formation and the role they play in final print quality (e.g., resolution, interlayer adhesion, mechanical properties).

The systems and methods disclosed herein have a wide variety of potential applications. For example, the presently disclosed systems and methods provide recyclable alternatives to current uses of printed thermosets, which can be used in a wide variety of commercial applications. These include, by way of non-limiting examples, use in optics, prosthetics, mascara brushes, orthodontic retainers (due, at least in part, to the excellent biocompatibility and hemocompatibility of PMMA), or other medical implants. For example, the high impact strength (approximately in the range of about 2 kJ/m² to about 5 KJ/m²), high refractive index (approximately 1.59), and optical transparency allow IPP to be usable in the production of optical components from PS with complex geometries, such as small lens arrays. Due to challenges associated with its formability, PAN is currently only widely used in the form of fibers, which are assembled into membranes for filtration applications (e.g., dialysis or hot-gas filtration) or woven into high-strength fabrics for textile applications (e.g., yacht sails). In some embodiments, PAN can be used in the manufacture of mechanical components (e.g., seals, washers) for applications that can exploit the chemical resistance of the polymer(s) and would benefit from the relative ease of processing and lower cost afforded by the raw material compared to industrially produced alternatives such as PTFE.

One exemplary method for fabricating a polymer object includes forming an immiscible liquid-liquid interface with a first liquid comprising at least a first monomer and a second liquid comprising at least a photoinitiator. The method also includes irradiating the immiscible liquid-liquid interface with light to cause at least the photoinitiator to react with the first monomer in a reaction zone proximate to the immiscible liquid-liquid interface to form a first film.

The method can further include positioning a build plate at or proximate to the liquid-liquid interface such that the first film is formed thereon. In some embodiments, the method can further include adjusting a height of the liquid-liquid interface after the first film is formed. Adjusting the height of the liquid-liquid interface can include adjusting a position of the build plate relative to the liquid-liquid interface. Adjusting the position of the build plate can include lowering the build plate at discrete intervals to maintain a solid-free reaction zone for formation of at least a second film. In some embodiments, adjusting the position of the build plate can include lowering the build plate at least one of substantially continuously, at a constant velocity, and/or at a changing velocity to maintain a solid-free reaction zone for formation of at least a second film. The second film can be added to the first film such that the first film and the second film form a single contiguous object. The polymer object can be formed by physical entanglement of newly formed polymer in the second film with previously formed polymer in the first film.

In some embodiments, the method can further include controlling one or more parameters of the reaction of the photoinitiator with the first monomer, with the one or more parameters comprising one or more of a nature of the two liquid phases, a light focal point on or near the liquid-liquid interface, a shape of an image projected, an exposure wavelength, intensity, or time, or the comparison of the formed film position to a build plan or to an image focal plane.

Tone or more of a linear chain polymer, a thermoset, and/or a thermoplastic. In some embodiments, a reactive species in the first liquid can have sufficient affinity with a second liquid to partition in the second liquid and react with a complementary reactant dissolved in the second liquid.

Another exemplary embodiment of a method for fabricating a polymer layer includes forming an immiscible liquid-liquid interface with a first liquid comprising at least a first monomer and a second liquid comprising at least a photoinitiator. The method also includes irradiating the immiscible liquid-liquid interface with light to cause at least the photoinitiator to react with the first monomer in a reaction zone proximate to the immiscible liquid-liquid interface to form at least a first film of the polymer layer.

The method can further include spatially adjusting a location of the light relative to the liquid-liquid interface to focus the light in a desired spatial distribution on the interface or on the reaction zone. In some embodiments, the method can include adjusting a height of a build plate positioned at the liquid-liquid interface in response to a controller that controls one or more of activation of the light, position of the light, or outflow of the first liquid or the second liquid from a vessel in which the liquids are contained.

In some embodiments of the method, the first liquid can include one or more of acrylonitrile (AN), polyacrylonitrile (PAN), styrene, polystyrene, methylmethacrylate, or polymethylmethacrylate (PMMA). The second liquid can include a water-soluble photoinitiator dissolved in an aqueous solution. For example, the second liquid can include an antisolvent, with the antisolvent including one or more of hexane, heptane, octane, or isooctane.

A depth of the reaction zone can define an upper limit of a thickness of the first film. The light can be projected onto the liquid-liquid interface through a mask image. The first film of the polymer layer can include the structure of the mask image.

### BRIEF DESCRIPTION OF THE DRAWINGS

This disclosure will be more fully understood from the following detailed description, taken in conjunction with the accompanying drawings, in which:

FIG. 1A is a perspective view of a schematic illustration of one exemplary embodiment of an IPP printing system having a UV light image of a mask projected at an interface of two liquids in a vessel to facilitate a photopolymerization reaction to form a layer of polymer;

FIG. 1B is a schematic illustration of a reaction zone formed at the interface of FIG. 1A;

FIG. 1C is a graphic illustration of a reaction that occurs within the reaction zone of FIG. 1B;

FIG. 1D is a perspective view of a schematic illustration of the system of FIG. 1A having a polymer film formed therein after exposure to the UV light for a given amount of time;

FIG. 1E is a schematic view of a thin solid polymer layer of the polymer film of FIG. 1D formed at exposed regions of the interface of FIG. 1B;

FIG. 1F is a magnified schematic view of a swollen polymer film of FIG. 1E;

FIG. 2A is a perspective view of a schematic illustration of the IPP printing system of FIG. 1A to facilitate a photopolymerization reaction to form a multilayer object at an interface of two liquids within the vessel;

FIG. 2B is a schematic illustration of a reaction zone formed at the interface of FIG. 2A:

FIG. 2C is a graphic illustration of a reaction that occurs within the reaction zone of FIG. 2B;

FIG. 3A is a schematic illustration of a free radical IPP reaction of PAN formation from acrylonitrile which is used as an organic phase of one of the two liquids in embodiments like the embodiment of FIG. 1A;

FIG. 3B is a graphic illustration of absorbance spectra of two aqueous photoinitiators and comparison with an emission spectrum of the LED light source of the system of FIG. 3A;

FIG. 3C is a perspective view of one embodiment a single-layer IPP printing apparatus;

FIG. 3D is a schematic side view of an optical train diagram of an IPP projection setup used with the apparatus of FIG. 3C;

FIG. 3E is perspective view of a cuvette of the apparatus of FIG. 3C for holding embodiments like the liquids and the polymer film of FIG. 1A therein;

FIG. 3F is a bottom view of a printed PAN film following a printing operation using the apparatus of FIG. 3C;

FIG. 3G is a bottom view of a mask image used with the apparatus of FIG. 3C;

FIG. 4 is a schematic illustration of one embodiment of an IPP three-dimensional printer for printing an object;

FIG. 5 is a side view of one embodiment of a multilayer IPP printing system having a build plate attached to a manual Vernier and attached to a side of a cuvette;

FIG. 6A is a cross-sectional view of a multi-layer printed polymer showing layering of alternating high-density PAN layers with low density layers, the low density layers including PAN swollen with glycerol;

FIG. 6B is a magnified side view of a scanning electron microscopy (SEM) image of the low density layer of FIG. 6A;

FIG. 6C is a magnified side view of a scanning electron microscopy (SEM) image of the high-density PAN layer of FIG. 6B;

FIG. 6D is a magnified side view of the low density layer of FIG. 6A having a crack formed therein; and

FIG. 7 is a schematic diagram of one exemplary embodiment of a computer system upon which the control system of the present disclosures is built.

### DETAILED DESCRIPTION

Certain exemplary embodiments will now be described to provide an overall understanding of the principles of the structure, function, manufacture, and use of the systems, devices, and methods disclosed herein. One or more examples of these embodiments are illustrated in the accompanying drawings. Those skilled in the art will understand that the systems, compositions, and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure. Like-numbered components across embodiments generally have similar features unless otherwise stated or a person skilled in the art would appreciate differences based on the present disclosure and/or his/her knowledge. Accordingly, aspects and features of every embodiment may not be described with respect to each embodiment, but those aspects and features are applicable to the various embodiments unless statements or understandings are to the contrary. The present disclosure includes some illustrations and descriptions that include prototypes or bench models. A person skilled in the art will recognize how to rely upon the present disclosure to integrate the techniques, systems, devices, and methods provided for into a product, such as a three-dimensional printer and/or a composition for use with the same. Still further, to the extent that the instant disclosure includes various terms for components and/or processes of the disclosed systems, methods, and the like, one skilled in the art, in view of the claims, present disclosure, and knowledge of the skilled person, will understand such terms are merely examples of such components and/or processes, and other components, designs, processes, and/or actions are possible.

At least one novel aspect of the present disclosure generally relates to Interfacial Photopolymerization (IPP) to enable photopolymerization additive manufacturing (AM) of linear chain polymers or thermoplastics. The technique enables use of recyclable, commercially available thermoplastic materials to form recyclable objects, though the technique disclosed herein can be applied to non-recyclable linear chain polymers, many of which cannot be printed by other methods. In IPP, a polymer film can be formed at an interface between two immiscible reactive liquids, each containing a species involved in the polymerization reaction. For example, one of the immiscible phases contains a photoinitiator, while the other contains a monomer, e.g., a chain growth monomer, or prepolymer, with the photoinitiator and monomer being segregated between two phases that form a stable planar liquid-liquid interface. The polymerization process and resolution can be controlled by an LED light source, which can be focused at a reaction zone located at or near a planar liquid-liquid interface. This method can provide for high-resolution, high-throughput AM of thermoplastic polymers that enables on-demand production of objects whose dimensional quality, mechanical properties, and/or recyclability rival that achieved by injection molding. In some embodiments, the presently disclosed techniques can be associated with a projector-based or laser-based three-dimensional (3D) printer to additively manufacture an object from the photopolymerized thermoplastics.

The presently disclosed methods of IPP differ from prior art polymerization reactions in that conventional techniques feature an inert liquid-liquid interface where one liquid phase is a mixture of all reactive species and the other does not contain any reactant for the polymerization reaction. The liquid-liquid interface of the present embodiments is not inert. Rather, polymerization occurs at the liquid-liquid interface of the present embodiments. Moreover, the photopolymerization reaction of the present embodiments can be spatially controlled, which allows control over the location at which the polymer is formed and/or the growth rate, or rate, of polymer formation. Spatial control of the present embodiments is facilitated by entanglement of newly formed polymer with previously formed polymer, rather than curing of photopolymers on a layer-by-layer basis as is practiced conventionally. Polymer formation by entanglement is a physical means of polymer formation as opposed to chemical curing of conventional methods. The physical means allows the polymer to remain at a desired location in the printed layer rather than dispersing through the liquids in which the layers are contained.

There are many commercially important polymer systems that cannot be processed using current AM capabilities. For example, printing low density polyethylene (LDPE), which is widely used for its low cost and good weatherability, has been unsuccessful to date due, at least in part, to poor bed adhesion and high shrinkage. Polyvinyl alcohol (PVA) is a biodegradable thermoplastic, but cannot be used in melt-based processes due, at least in part, to the polymer degrading at a temperature below its melting point. Another example is polyacrylonitrile (PAN), an industrial polymer that is perhaps best known as a carbon fiber precursor material, but can also be widely used in applications including textiles, filtration, and concrete reinforcement, among other applications. PAN not only degrades before melting but can form dangerous hydrogen cyanide as a degradation by-product. Melt-processing of PAN can be accomplished through the addition of non-solvent plasticizers, though this generally requires plasticizer that is approximately in the range of about 20 wt % to about 50 wt %. The plasticizer is typically later removed. Another method involves the introduction of co-monomers, e.g., the common fused filament fabrication (FFF) material acrylonitrile butadiene styrene (ABS), though these formulations contain ˜35% or less acrylonitrile and the final material properties can be strongly influenced by the proportions of the components.

A person skilled in the art will recognize that not all processing methods are suitable for all materials. For traditional injection molding, the polymer used is a thermoplastic, i.e., one that is moldable under heat and/or pressure. Thermoplastics comprise linear chains that can slide past one another at elevated temperatures, allowing the polymer to flow and be reshaped. This property, at least in part, makes thermoplastics the most readily recycled class of polymers. Historically, the labor associated with collecting and sorting used materials, the degradation of plastic with each reclamation process, and the low cost of virgin materials, among other factors, has made recycling a difficult economic prospect. However, growing investment in automated spectroscopy equipment to sort plastic waste can reduce labor costs and increase the economic viability of recycling.

As mentioned above, to expand the use of thermoplastics in AM, it is desirable to develop AM processes that are cost-effective, compatible with a wide variety of polymers, and/or enable the production of high-quality parts. Contrasting selective laser sintering (SLS) and fused filament fabrication (FFF), AM methods that use photopolymerization can produce parts with superior surface finish and detail. Photopolymerization methods also overcome the mechanical property limits of SLS and FFF, as cure-through from layer-to-layer results in isotropic elastic properties and increased crack propagation resistance. The common parent technology of photopolymerization AM is stereolithography (SLA), which uses point-source illumination from a rastering laser to expose each layer. Digital light processing (DLP) SLA projects a pattern into the resin and polymerizes each layer at once. SLA also presents a tradeoff between build speed and resolution, but projector-based methods are generally faster than laser-based analogues.

### Interfacial Photopolymerization (IPP)

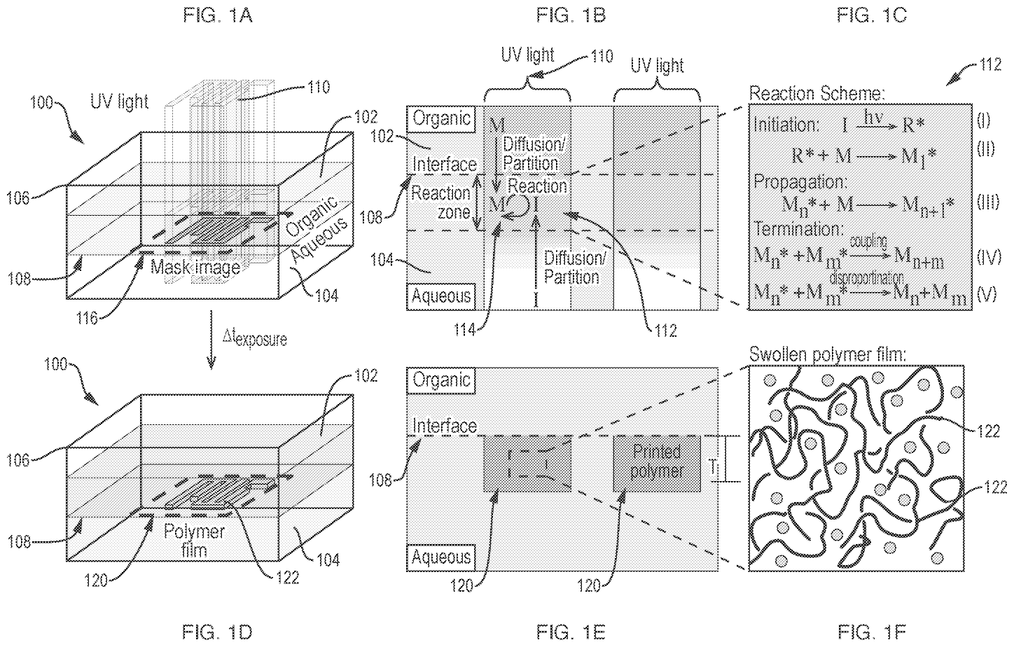

IPP relates to the formation of high-resolution printed patterns of polymer from reactants segregated between two immiscible phases, and the entanglement of the resulting polymer layer-by-layer into a bulk object. FIGS. 1A-1D illustrate an exemplary embodiment of a system of IPP 100 as a method for high-resolution digital processing of polyacrylonitrile (PAN). As shown, the system 100 can include an organic liquid or organic phase 102, an aqueous liquid or aqueous phase 104 contained in a vessel, e.g., vat 106. The organic phase 102 can also include one or more monomers, e.g., acrylonitrile (AN), styrene, methyl methacrylate, along with a co-solvent or anti-solvent such as hexane, heptane, octane, isooctane, and so forth, while the aqueous phase 104 can include one or more photoinitiators, e.g., Fujifilm VA-050, 2,2′-Azobis(2-methylpropionamidine) dihydrochloride, which can be considered an azo initiator, among others. In some embodiments, the organic liquid 102 can include monomer as well as dissolved polymer (e.g., PMMA) and antisolvent (e.g., hexane) to induce precipitation. It will be appreciated that while the present disclosure discusses photopolymerization printing of polyacrylonitrile (PAN), which is a high-performance linear chain polymer, one skilled in the art will recognize that this polymer is merely exemplary. PAN is known for its cyclization at high temperature and can be used as a carbon fiber precursor. From this perspective, the thermal stability of IPP PAN can lend itself to use in the polymer formation of the present embodiments due, at least in part, to its insolubility in its monomer, e.g., acrylonitrile (AN). Use of PAN can therefore allow for use of a pure monomer in the liquid of the organic phase without using an antisolvent. Moreover, it will be appreciated that in some embodiments, the aqueous phase 104 can instead include the monomer and the organic phase 102 can include the initiator.

The IPP process can be characterized by the use of a bulk interface between immiscible liquids, contrasting existing photopolymerization printing methods that produce crosslinked polymers from a single resin phase. As shown, the organic liquid 102 and the aqueous liquid 104 can be visibly separated, with a density of the organic liquid being less than that of the aqueous liquid 104 such that the organic liquid 102 is separated from the aqueous liquid 104 at an interface or boundary 108. That is, in IPP, the monomer and the photoinitiator can be segregated between the two phases such that the reaction can occur at the liquid-liquid interface 108. It will be appreciated that in some embodiments, the aqueous liquid 104 can be less dense than the organic liquid 102 such that the aqueous liquid 102 is suspended above the organic liquid 102.

IPP can utilize several aspects of emulsion polymerization without causing emulsification. Namely, IPP can involve the polymerization of an organic phase monomeric system using an aqueous phase initiator. A person skilled in the art will recognize that emulsion polymerization processes typically use surfactants (e.g., small molecules with a hydrophobic tail attached to a hydrophilic head group) that serve to stabilize droplets of monomer and increase surface contact area between the two phases. Above a critical concentration, the excess surfactant molecules in solution can group together in an aqueous solution and assemble with the head groups facing outwards and the tail groups protected within the assembly, sometimes referred to as a micelle. The micelles can create an extremely high contact area between the water-soluble initiator and the monomer, and the polymerization process proceeds at this interface 108. As the monomer within the micelle is depleted (e.g., converted to polymer), more monomer diffuses from the droplets and the polymerization can continue. The result is a dispersion of polymer particles stabilized within an aqueous medium, known as a latex.

In contrast, IPP does not utilize surfactants and there is no emulsification. The solubility of monomer in the water phase for the material sets is small, but the monomer within the aqueous phase can react with the initiator. The monomer concentration near the liquid-liquid interface 108, close to the large reservoir of monomer, can be at the saturation limit. A light source 110 that controls where the initiation and subsequent polymerization reaction occurs can be focused at this planar interface, as described in greater detail below.

An archetypical characteristic of the polymers used in latex dispersions is their solubility in the liquid monomer. For example, in some embodiments, a bulk organic solution can contain a monomer having very sparing solubility in the aqueous phase 104, with the monomer in the aqueous phase 104 reacting with the photoinitiator and another monomer to form an oligomer. As the oligomers (e.g., the short chains of early-stage polymerization) grow in size, they can become increasingly hydrophobic. Without surfactant to stabilize them within the aqueous phase, they will be thermodynamically driven to partition back into the organic phase 102 and thus readily re-absorb into the organic phase. This can be unsuitable for IPP, however, because it means the printed part is continuously dissolving into the larger bath of unreacted resin during the nascent stages of formation. Therefore, the solubility of the polymer in the bulk phases can be a metric in determining the printability of a given material set.

For IPP to proceed and a linear chain polymer film to form and retain its geometry, the system has two additional characteristics beyond the existence of a liquid-liquid interface. First, in IPP of the present embodiments, the species of one phase (e.g., monomer in the organic phase 102) can react with species in the second phase (e.g., initiator in the aqueous phase 104), but each is at best sparingly soluble in the opposing phase. Sparing solubility can allow the monomer contained in the organic phase 102 to diffuse and partition into the aqueous solution, which will result in the presence of both the monomer and initiator in a shallow region near the liquid-liquid interface 108 where the reactants are in close proximity, which can be referred to as a reaction zone 114.

FIG. 1B illustrates the reaction zone in greater detail. For example, the reaction zone 114 can be formed in, or proximate to, a portion of the liquid-liquid interface 108 to facilitate a reaction occurring to an area of the liquid-liquid interface 108 that is exposed to light. For the purposes of this disclosure, the reaction zone 114 being proximate to the liquid-liquid interface 108 can denote the reaction zone 114 being disposed adjacent to the liquid interface 108, in contact with the liquid-liquid interface, within one or more liquids that form the liquid-liquid interface 108, or at a distance from the liquid-liquid interface that is equal to a thickness of one or more layers of the film being formed.

As shown in FIG. 1B, the polymerization process and resolution can be controlled by a light source 110 focused at the reaction zone 114 located at or near the planar liquid-liquid interface 108. The light source 110 can provide the desired spatial resolution of the printed layer by controlling where photoinitiation occurs. For example, IPP may be employed by a printer with either a laser or an LED light source, or any other excitation source that works for the selected polymer. It will be appreciated that a variety of different optical setups can be used, including but not limited to a single-layer apparatus, a multiple layer apparatus, a DLP printer, and other kinds of printers.

As shown, the light source 110 can be externally projected onto the system 100 such that a light image of a projection mask 116 can be projected at the interface 108. It will be appreciated that the projection mask 116 can be used as the light source 110 for its potential for fine features and cost-effective scalability, as demonstrated by other projection-based photoprinting methods. Some non-limiting examples of the light source 110 can include a light-emitting diode (LED), an ultraviolet (UV) light, a laser, and/or a digital micromirror device. For a UV light source, the mask image 116 can be projected at the liquid-liquid interface 108, which can trigger free-radical poly-addition in the exposed areas. By projecting an image of the desired layer geometry within the plane of the interface 108, selective photopolymerization can be achieved, with the interface 108 representing each instantaneous layer of the print. The resolution for printing thermoplastics with IPP can be equivalent to analogous DLP processes for thermosets (˜50 microns or less), and competitive with incumbent DLP build rates for thermosets (˜10 s of millimeters/hour) due, at least in part, to comparable reaction kinetics.

In some embodiments, a macrokinetics model can be used to describe the reaction kinetics and consequent build rates of the presently disclosed system 100 and methods. The setup of this model can be based on the relative arrangement of elements of the system 100. For example, in such a model: (a) an initiator I can be dissolved in the aqueous phase 104; (b) the organic phase 102 can be less dense than the aqueous phase 104, and can be located between the light source 110 and the aqueous phase 104 such that the light path travels through the organic phase 102—which has no initiator—before reaching the aqueous phase 104; (c) monomer M diffuses from the bulk of the organic phase 102 to the vicinity of the interface until an equilibrium distribution (governed by the partition coefficient K_{[M],as}) between the aqueous and the organic phase 102 is established; and (d) the reaction zone 114 can be defined by the region where the light used to dissociate the photoinitiator is focused, and is at or near the liquid-liquid interface 108.

Polymerization can occur with I dissociating to form free radicals R*, which subsequently react with monomer molecules to initiate chain growth (initiation). Polymer chains then grow (propagation) before being capped either by combination or disproportionation (termination) or chain transfer. That is, as shown in FIG. 1C, as the photoinitiator within a desired region is activated via the light source 110, it will dissociate to generate free radical R*, as illustrated at action (I), that will react and consume local monomer M from the organic phase 102 in a free-radical polyaddition reaction to create an active radical M*, as illustrated as action (II). The active radical M* can propagate to form a polymer chain, as illustrated as action (III). The monomer M can then, in turn, be replenished from the bulk phase. This process can be allowed to proceed until the desired polymerization for the printed layer has been achieved. Once the polymerization has been achieved the active radicals M* can be coupled to one another, as shown as action (IV), or disproportionated, as shown as action (V), to terminate the reaction.

As polymerization proceeds, reactants are consumed, and their respective concentrations are locally depleted. This creates a concentration gradient that drives a given reactant species to diffuse into the reaction zone 114 from the bulk solution. By the conservation of mass, the concentration of a species at a given time within a control volume is given by Equation (1):

$$\frac{{d [ X ]}_{z}}{dt} = \text{} \sum {r}_{generation} - \text{} \sum {r}_{consumption} + \sum {r}_{transport In} - \sum {r}_{transport Out} \qquad ( 1 )$$

where X denotes one species (e.g., monomer, initiator) and the superscript z denotes the phase (s for the organic phase, a for the aqueous phase, and r for reaction zone). Σr_{generation} is the sum of the reaction rates that result in the production of X, Σr_{consumption} is the sum of the reaction rates in which X is depleted, and Σr_{transportIn} and Σr_{transportOut} are the sum of diffusive and convective mass transfer of the species in and out of the control volume, respectively.

The use of two immiscible liquids can offer a further strategic advantage in creating a thermodynamic trap for precipitation of nascent polymer. For example, the particles can replace a portion of the high energy liquid-liquid interface with the lower energy liquid-solid interface, leading to an overall reduction in total interfacial free energy. As the polymer chain grows in size, it can become increasingly difficult for it to leave the interface. This can cause a local trapping of the polymer while it propagates, until it has sufficiently coagulated into a contiguous layer.

The second additional characteristic of the present system 100 that allows IPP to proceed and a linear chain polymer film to form and retain its geometry can include the resulting polymer being insoluble in both phases to successfully precipitate as a continuous film upon chain propagation and termination. FIGS. 1D-1F illustrate formation of a polymer film 120 at the liquid-liquid interface 108. As shown, water immiscible polymer chains 122 can precipitate out of solution after reaching a critical chain length and form a thin solid polymer layer 120 at the exposed regions of the interface 108. As shown, the PAN film 120 can be formed on the aqueous side of the liquid interface due to preferential diffusion-partitioning of PAN into the water-glycerol solution. In some embodiments gas bubbles can be formed and trapped at the liquid-liquid interface upon UV exposure, due, at least in part, to the generation of nitrogen as a by-product of the azo initiator decomposition reaction.

Solubility of the polymer in both phases can be finely controlled to trigger precipitation at high polymer molecular weight and ensuring polymer film integrity and high spatial resolution. For example, the liquid, e.g., the organic liquid 102 saturates with polymer before any polymer can precipitate out to form a desired object. As shown, high entanglement can be used to obtain spatial fidelity through the formation of a solvent-swollen polymer. A low molecular weight can result in low entanglement and poor spatial fidelity, while a high molecular weight polymer can enable trapping of the polymer chains and a stable swollen polymer film.

A higher molecular weight can promote greater interchain interaction by entanglement and therefore minimize diffusion of the polymer chains at the interface, outside of the UV-exposed area. Accordingly, large values of molecular weight (Mₙ>10,000 g mol⁻¹) help ensure high resolution by photoprinting with IPP.

A thickness T of the polymer film 120 can vary. In some embodiments, a depth of the reaction zone 114 can be an upper limit of the thickness T of the polymer film 120. The depth of the reaction zone 114 can be defined by one or more of, or a juxtaposition of, the light penetration distance and the monomer diffusion length onto the phase where the reaction occurs. For example, the polymer can form within the reaction zone 114 where both species are present. This can be in either of the organic phase 102 or the aqueous phase 104 depending on the respective affinity of the reactive species towards the two immiscible solvents. Specifically, the reaction zone 114 can be formed where a reactive species in either of the organic phase 102 or the aqueous phase 104 has sufficient affinity with the other of the organic phase 102 or the aqueous phase 104 to partition and react with a complementary reactant dissolved in the other phase. The location of the reaction zone 114 can define where the polymer forms.

A person skilled in the art will recognize that a common way to evaluate the reaction zone depth in interfacial polymerization is to consider the penetration depth of the monomer in the aqueous phase 104 or the characteristic length over which the light used to trigger the reaction is absorbed in the phase in which the reaction occurs.

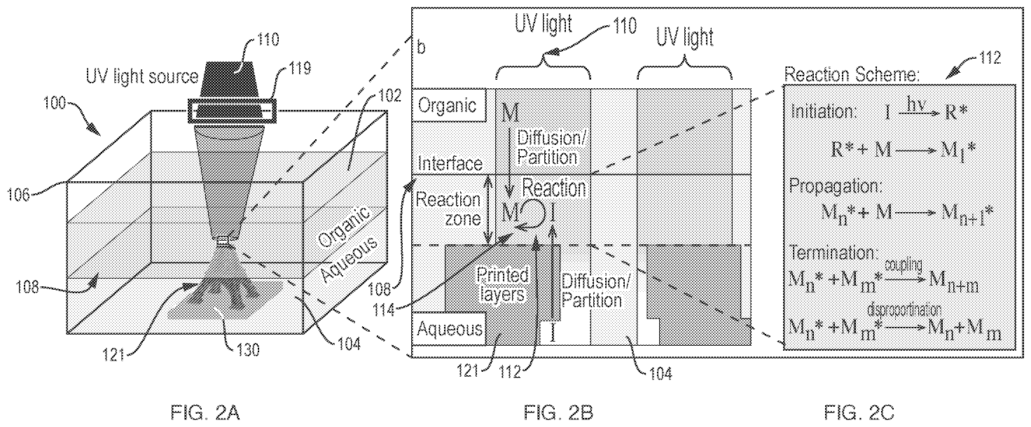

FIGS. 2A-2C illustrate the IPP printing system 100 having a UV light source printing an object 121 at the interface 108. It will be appreciated that the IPP printing system 100 can be used with a digital micromirror device (DMD) 119 in lieu of a mask, as shown, with the DMD device facilitating formation of a layer pattern of the object by shaping the light from the light source. The object 121 can be formed of a plurality of polymer film layers 116 that are associated with one another to form a single contiguous object. As shown, the object 121 can be disposed on a build plate 130, with the build plate 130 being configured to move away from the liquid-liquid interface 108 to print a subsequent layer of polymer on the previous layer of polymer until the object 121 is formed. It will be appreciated that movement between the liquid-liquid interface 108 and the build plate 130 can be relative such that in some embodiments, a height of the liquid-liquid interface 108 can be adjusted to move away from the build plate 130.

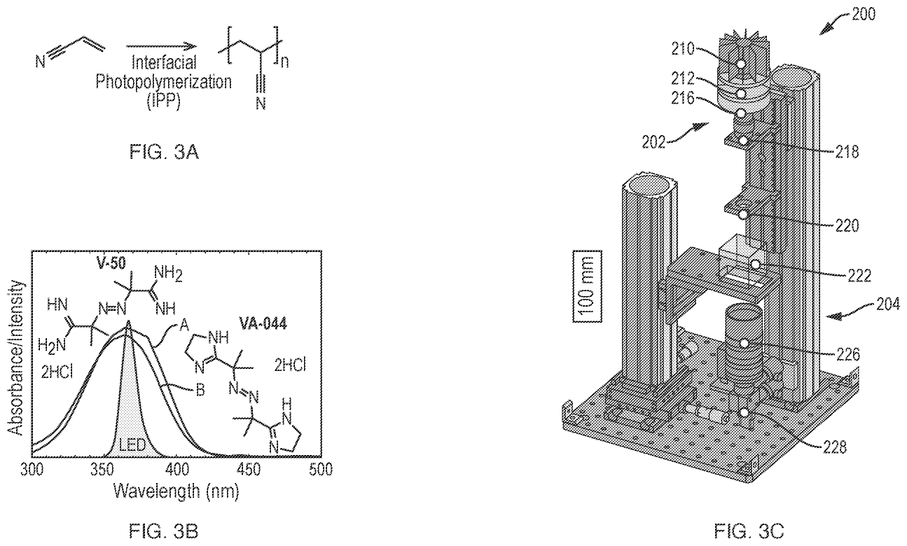

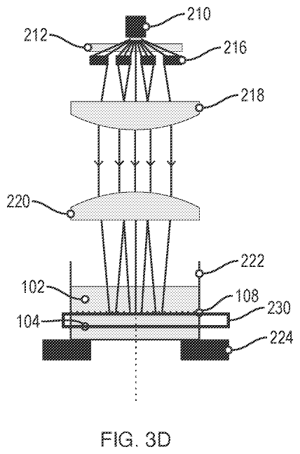

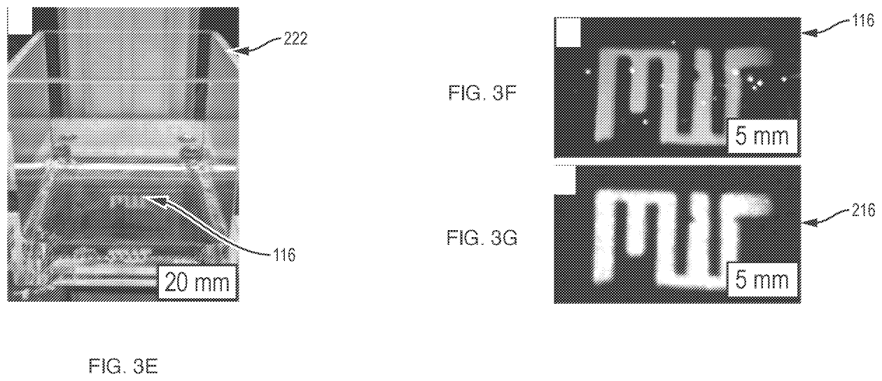

Polyacrylonitrile (PAN), obtained by the free-radical addition reaction of acrylonitrile (AN), satisfies all the above-mentioned additional characteristics without further modification. While acrylonitrile (AN) has some solubility in water, PAN is insoluble in both AN and water. As a result, the free-radical chain-growth reaction of AN with a water-soluble photoinitiator can be used to demonstrate IPP in a single-layer photoprinting scheme, as shown in FIG. 3A. In this reaction, the organic phase 102 can be pure inhibitor-free AN which is reacted on the aqueous side 104 of the interface 108 to form PAN upon UV exposure. The aqueous phase 104 can include a water-soluble photoinitiator dissolved in a 37.5 vol % glycerol-water solution. The addition of glycerol can increase the density of the aqueous phase, thereby preventing the PAN film from sinking over extended periods of times (˜minutes). In some embodiments, the photoinitiator can be dissolved at 1% or 2% in 10 mL of a mixture of water and glycerol. Glycerol can be added to the water in order to increase the density of the bottom phase and prevent the polymer from sinking to the bottom of the vessel in absence of a build plate.

FIG. 3B illustrates absorbance spectra of two exemplary embodiments of aqueous photoinitiators as compared to the emission spectrum of an LED light source. The aqueous photoinitiators can include two commercially-available water-soluble azo-photoinitiators (Wako V-50 (A) and VA-044 (B)) which both feature absorption bands corresponding to the emission spectrum of the 365-nm UV LED of choice. Each of the initiators results in cationic end-groups with different reactivity and overall stability. Due to its non-nitrile nature, VA-044 (B) can usually be less active than V-50 (A) at room temperature but also less prone to hydrolysis, which would result in stable, non-radical decomposition product.

IPP can show in-plane resolution on-par with that of conventional photoprinting methods and cohesive PAN films with a number average molecular weight greater than 10 kDa. IPP can reduce the prevalence of non-recyclable photopolymers in AM by enabling photopolymerization of widely desirable thermoplastics. Moreover, IPP can avoid key challenges associated high-temperature processing of thermoplastics by extrusion-based or laser-based AM methods, such as anisotropy of mechanical properties, and residual stresses induced during cooling that can cause warping or interlayer delamination.

FIG. 3C illustrates an exemplary embodiment of an IPP printing apparatus 200 that include a single-layer projection system 202 equipped with a bottom-view imaging system 204 to assess the process in-plane resolution. The apparatus 200 can include a UV-LED 210 in communication with a diffuser 212 and a mask 216 such that the mask 216 can be illuminated by the diffused light from the UV-LED 210. The light can pass through a collimating lens 218 and a focusing lens 220 towards a cuvette 222 in which photopolymerization occurs. In some embodiments, the collimating lens 218 and the focusing lens 220 can be configured to focus on the liquid-liquid interface 108 with a magnification ratio of two focal lengths while being substantially independent of the bottom-view imaging system 204. In some embodiments, the cuvette 222 can be positioned on a translatable stage 224, as shown in FIG. 3D, whose position can be configured to be adjusted to select a specific position for photopolymerization to occur. The cuvette 222 can include the reaction medium disposed therein. A macrolens 226 and a camera 228 can be disposed opposite the LED to observe a single layer and compare its shape to the area exposed with UV light, e.g., the mask 216.

FIG. 3D schematically illustrates operation of the apparatus 200 of FIG. 3C in greater detail. Light from the UV-LED 210 can pass through the mask 216, with the mask image being collimated and refocused at the liquid-liquid interface 108 using the collimating lens 218 and the focusing lens 220. The mask 216 can be disposed in front of the excitation light source to control exposure and project the image onto the liquid-liquid interface 108. The light can then be focused on particular regions of the AN-aqueous interface that mimic the exposed area of the optical mask 216 to print the PAN film. In some embodiments, the apparatus 200 can include a build plate 230 that is associated with the cuvette 222. For example, in some embodiments, the build plate 230 can be disposed in the cuvette 222 to hold the printed film and/or object thereon. The build plate 230 can be positioned at, or proximate to, the liquid-liquid interface 108 and be configured translate in a proximal-distal direction to remain at the interface 108 throughout the reaction.

FIG. 3E illustrates the cuvette 222 having the printed PAN polymer layer 116 disposed therein. As shown, the cuvette 222 can resemble the vessel 106 that can be configured to contain the reaction medium therein with the polymer printed at the interface. The polymer layer 116 and the mask image 216 can be seen in FIGS. 3F and 3G. As shown, the polymer layer 116 can resemble the mask image 216 through which the light was initially projected to indicate that the photopolymerization reaction occurs at desired locations along the interface.

A variety of constructions can be used to implement a printer that can utilize the IPP process. In some implementations, a two-dimensional printer capable of forming one layer uses a light source to selectively create polymer, and a platform supporting the materials forming the reactive liquid-liquid interface. In some implementations, a three-dimensional printer can include a structure that maintain a stable liquid-liquid interface 108. For example, some implementations may include structures that maintain the stable liquid-liquid interface while concurrently allowing for a build platform to move and incorporate consecutive layers. Moreover, while single-layer photopolymerization printing of PAN is discussed herein, the presently disclosed can be used in multi-layer photopolymerization printing. For example, the polymer film 120 of the present embodiments can be produced as a result of a two-dimensional (2D) architectural printing method, with the film 120 of the present embodiments being capable of functioning as an architectural foundation of an object and/or a multi-layer print. Multi-layer photopolymerization printing is discussed in greater detail below.

Conventional photopolymerization AM methods rely on an intrinsic crosslinking mechanism. For example, the materials used in these reactions are thermosets, not thermoplastics. As a result, the intricate detail and material variety achieved in the output products come at the expense of compatibility with large-scale recycling processes that are designed for thermoplastics and rely on melting and reshaping the material. To the extent that conventional photopolymerization AM methods can be applied to conventional thermoplastics, such a relationship can be seen with respect to thermoplastic polyurethanes, a narrow subcategory of polymers that feature physical cross-linking between the chains to induce precipitation. Crosslinks are chemical bonds between polymer macromolecules that occur at points other than their ends, forming interpenetrating networks. As the degree of crosslinking in the system increases, so does the rigidity and brittleness of the polymer solid. When heated, the polymer chains cannot slide past each other as they can in the linear chain systems, and therefore the system cannot be reformed into new shapes. The cross-linked systems are generally not recyclable, which exacerbates the creation of plastic waste as AM's adoption grows. Indeed, conventional photopolymerization 3D printing is incompatible with linear chain polymers that do not feature additional strong interchain interaction (e.g., hydrogen bonding, electrostatic interaction forming physical crosslink like in the case of TPUs). This is because in conventional photopolymerization 3D printing, solidification and spatial trapping of the polymer is induced in the reactive vat, and this is not possible for linear chain polymers without strong interchain interaction. Some linear chain polymers may be able to precipitate out of their prepolymer mixture, but (1) this property is very rare in thermoplastics and (2) without interchain interaction, polymer chains will just disperse in the liquid bath instead of staying at the desired location of the printed layer. IPP, however, is broadly applicable to all linear chain polymers that can be obtained through photoinitiated free-radical polymerization, whether or not they feature cross-linking. This includes (but is not restricted to) vinyl polymers, poly(acrylics) or poly(methacrylics). The IPP reaction is localized at the liquid-liquid interface thanks, at least in part, to the reactant segregation between the two solvents. The reactive liquid-liquid interface can enable trapping of the polymer chains as a cohesive layer while tuning the chemical composition of both phases results in selective precipitation of the polymer chains as they form.

In some embodiments, the techniques discussed above can be used to print other types of compounds, e.g., thermosets. For example, a crosslinking agent can be added to the IPP printing system 1000 to print a thermoset. The thermoset materials produced by the presently disclosed techniques can achieve a superior resolution limit as compared to conventionally fabricated thermosets.

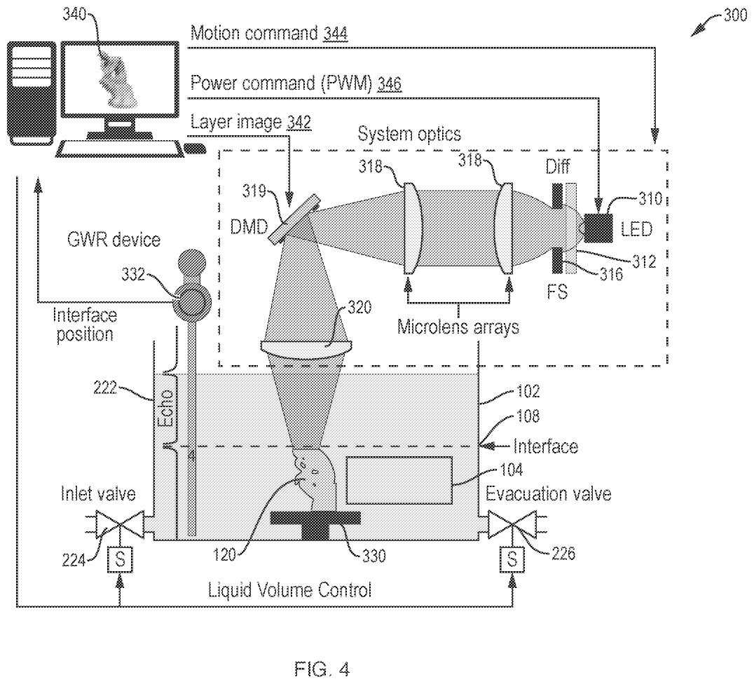

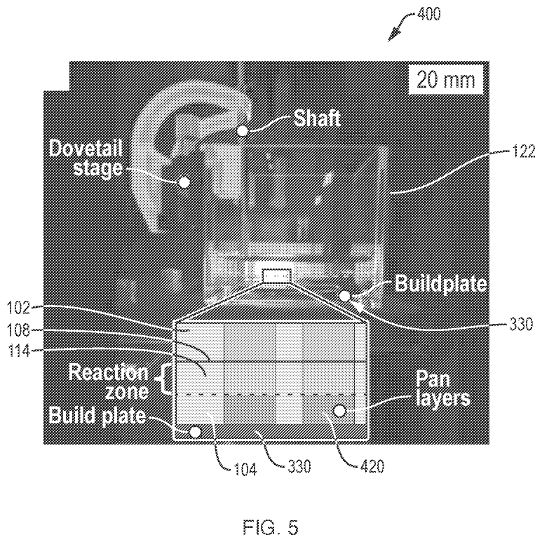

FIG. 4 illustrates an exemplary embodiment of an IPP 3D printer 300 that enables the translation of single-layer reaction parameters to the formation of macroscopic components. As shown, the printer 300 can incorporate many of the same features of the apparatus 200 in an overall printing system. In some embodiments, a digital projector can serve as the polymerization light source, and the IPP 3D printer 300 can therefore be analogous to commercial projector-based DLP systems. While the presently disclosed system can be used with a translatable build plate 130, 330, in some embodiments, the printer 300 can include a build plate or build platform that is substantially stationary or fixed. As mentioned above, and as shown in FIG. 4, the printed structure can be formed on the aqueous side of the liquid-liquid interface 108 due to preferential diffusion-partitioning of PAN into the water-glycerol solution. Stationary build plates can maintain the liquid-liquid interface 108 in a stable position, with the build plate 330 gradually being moved upward by pumping liquid into the bottom of the build tank. In some embodiments, this can be done in an incremental fashion with each layer, e.g., by advancing a syringe pump that feeds the tank. In some embodiments, a level of the liquid, and therefore the interface 108, can be adjusted via an inlet valve 224 and an evacuation valve 226 associated with the cuvette 222. Alternatively, or additionally, with improved control, the interface could be moved continuously and synchronously with image projection, achieving layer-free printing, such as used in other precision instruments with optical, motion, and/or thermal controls such as for DLP-based maskless photolithography, automated chemical vapor deposition, precision liquid dispensing, and/or high-speed FFF printing.

In traditional SLA-style printing (including DLP), the z-axis resolution can be determined by the incremental motion of the build platform (typically as small as about 25 μm). In some embodiments of the IPP printer 300, the z-axis resolution can be determined by the ability to precisely resolve the position of the liquid-liquid interface 108 and the depth of the reaction zone. In some embodiments, the printer 300 can include a sensor 332 to measure the interface position, such as a guided wave radar (GWR) device (e.g., Magnetrol Eclipse 706) or a confocal laser sensor (e.g., Micro-epsilon confocal DT IFS2407-0,1). A calibrated digital camera viewing the interface from the side can also be used.

The in-plane resolution of the IPP printer 300 can be governed by the projection light source and optics. A custom optical train can be designed to give both fine image resolution and optimized light intensity for the chemical reaction. For the light source, in some implementations, a single high intensity LED 310 (e.g., OSRAM LZ1-00UV0R), or an LED array (e.g., LEDsales WB UVC STAR) can be used to provide a broader wavelength range and greater light flux, the light uniformity can be improved by the use of a diffuser 312, and the incident light angle can be adjusted using a field stop (“FS”) 316. The light can then be collimated and refocused onto a digital micromirror device (DMD) 319 (e.g., Wintech W4100 development kit) with an attached control board. A lens 320 can be disposed downstream of the DMD 319 and can project the image onto the liquid-liquid interface 108 with a controlled magnification. In some embodiments, the system 300 can be monitored for the emergence of optical artefacts (e.g., aberrations or ghosting), which may be caused by erroneous reflections or stray light. To ensure even illumination, two microlens arrays 318 (e.g., Thorlabs MLA150-7AR-M) can be placed between the light source 310 and the DMD 319. A standard optical test pattern (e.g., USAF-1951, Thorlabs RIDSIP) can be used to determine the minimum line pair resolution, which can be the minimum distance between two parallel lines that can be distinguished with a contrast greater than 30%. At a magnification of 1×, the target in-plane resolution in some embodiments can be about 30 μm (approximately 3 pixels) for a projection width of about 0.95″ (an example size of the DMD array).

The IPP printer 300 can be controlled by a computer program executed on a computer 340 that is connected to control the various components through interfaces. Implementations of such a program can intake the 3D geometry to be printed (e.g., in .stl format), perform slicing of the geometry 342, and send motion commands 344 and projection commands 346 for each layer (slice) through the interfaces to the printer 300. In some embodiments, a custom hardware controller also can be built. In some implementations, the controller can use the interface position as an input, and for each exposure, the liquid level and the position of the optical train can be coordinated to focus the projection onto the liquid-liquid interface. LED forward voltage is known to vary with temperature and illumination time, so the light output of the LED 310 can be adjusted to ensure a stable intensity profile over time. Each module can be calibrated independently (e.g., axis position, speed, light distribution, and/or intensity measured by projecting onto a CCD). The performance of the system 100 can be evaluated, for example, by comparing projections on a paper screen placed at the interface to printing of the test pattern by IPP in each material. From this, the printer can be used to further validate the reaction parameters and explore layer-to-layer polymer network development.

Using IPP in a particular application can involve selection of material formulations of monomer, initiator, and solvent. These can be experimentally explored and validated based on polymer solubility parameters and other relevant metrics in view of the present disclosures. A person skilled in the art, in view of the present disclosures, is able to perform experiments to assess the relationships between reaction conditions (e.g., light intensity, photoinitiator or monomer concentration) and polymer product characteristics (e.g., molecular weight, density, print fidelity) for the material sets without undue experimentation.

### Feedback Controller

The hardware controller can be configured to be associated with a control loop that can be implemented to provide feedback to optimize one or more parameters of the instantly disclosed system. For example, the hardware controller can be associated with a microprocessor for implementing the control loop within the system 100. In some embodiments, the control loop can be configured to optimize a height and/or position of the liquid-liquid interface 108 to facilitate the photopolymerization reaction. As mentioned above, polymer formation occurs at the liquid-liquid interface 108, which suggests that controlling the height versus an optical focus of the system can dictate the location along the interface at which the photopolymerization reaction occurs. For example, in some embodiments, the light pattern can be controlled versus position and/or time based on sensing and/or prediction of the reaction rate. Moreover, with respect to the reaction rate, in some embodiments, the control loop can monitor the reaction rate to allow speeding up and/or slowing down thereof for polymer film formation. In such embodiments, the microprocessor can track the one or more parameters to control the reaction rate, with the reaction rate being based on such parameters, e.g., location of build plate. Some additional non-limiting examples of such parameters can include focusing the light source 110 on a specific location of the reaction zone 114, light parameters such as exposure wavelengths (with the wavelength corresponding to a photoinitiator being used), exposure intensity, position of the build plate (vertical position and in-plane position with respect to the light source), comparison of polymer formation, e.g., printing, to a build plan or to an image focal plane, and/or focus position of optical chain, among others. Alternatively, or additionally, the control loop can monitor ranges of amounts of reactive species within the photopolymerization reaction, among other parameters.

During the fabrication of objects, e.g., object 120, using IPP, it can be useful to evaluate various properties of the materials and objects being fabricated. For example, if the primary objective is to maximize the structural integrity of the objects, this can be done by creating maximally long polymer chains that can entangle during printing and thereby form a three-dimensional network with, ideally, isotropic mechanical properties. This can be achieved, for example, by optimizing the light intensity and/or exposure time. The initiation step of the polymerization can be photosensitive and the remaining steps can be governed by rate constants dominated by an Arrhenius law. An increase in temperature can increase the reaction rate but decrease the polymer molecular weight, which can be unfavorable for developing the entanglement that builds layer integrity. For the class of materials including PAN, PS, and PMMA, polymerization proceeds from a C═C bond converting to two C—C bonds, and is therefore exothermic (e.g., AH values of 73 KJ/mol of polymerized monomer for styrene). Excessive light energy can also generate extraneous heat within the system. If printing speed is allowed to proceed at a faster rate than the excess heat can be dissipated, the molecular weight, and therefore the mechanical properties of the print, can degrade as the print progresses. Initially, heat generation and dissipation can be optimized by monitoring the effect of the polymeric molecular weight distributions using gel permeation chromatography (GPC) and/or evaluating for consistency over long operation times.

Mechanical properties of objects can be measured by tensile and dynamic mechanical analysis (DMA), and can be evaluated for anisotropy resulting from build orientation. The degree of polymerization can be evaluated, for example, by GPC and/or differential scanning calorimetry (DSC), and/or X-ray computed tomography (CT) can be used to assess the porosity of the objects, among other evaluation techniques. This information can be used to iterate on the exposure parameters and input material formulations to improve the properties.

### Multi-Layer

The Interfacial Photopolymerization printing process can also be integrated in a multilayer scheme to demonstrate translation from film formation to 3D printing. FIG. 5 illustrates an exemplary embodiment of printing using a multilayer scheme. As shown, the system 400 can include a manual build plate 330 that can translate up and down in the cuvette 122. The present illustration is a bench model, and thus the build plate 330 can be composed of filter paper stretched onto a stainless-steel frame and clipped with paper clips. The first layer can be printed by bringing the build plate 330 as close as possible to the liquid-liquid interface 108 while remaining below the interface 108. The exposure can be turned on to induce polymerization, precipitation, and/or formation of the first polymer layer 420. For subsequent layers of the multilayer polymer film 420, the build plate 330 can be lowered by a measured distance below the liquid-liquid interface 108 to expose a solid-free reaction zone 114 where a new polymer film 420 can form upon light exposure.

The build plate 330 can be lowered in discrete steps followed by punctual exposure for layer formation. Additionally, or alternatively, it can be moved at a constant velocity, at a changing velocity, and/or substantially continuously in tandem with substantially uninterrupted light exposure of the liquid-liquid interface 108 to facilitate substantially continuous polymer formation. A person skilled in the art will recognize that the term “substantially” in context of substantially continuous can refer to a layer of polymer being formed five seconds or less after the layer prior has been completed. For example, in some embodiments, the build plate 330 can be lowered in discrete steps of about 100 μm followed by about thirty seconds of light exposure for each layer. As shown in FIG. 5, the build plate 330 can be attached to a manual Vernier 134 that can be attached to the side of the cuvette 122, though it will be appreciated that the vertical motion can be ensured by any one-dimensional motorization, either manual or automated. Light exposure patterns for all the layers can be the same, with good spatial fidelity for multilayered patterns being printed. As additional layers are printed, a linear dependence between a printed height (hₚ) and the number of layer can exist for multilayer schemes.

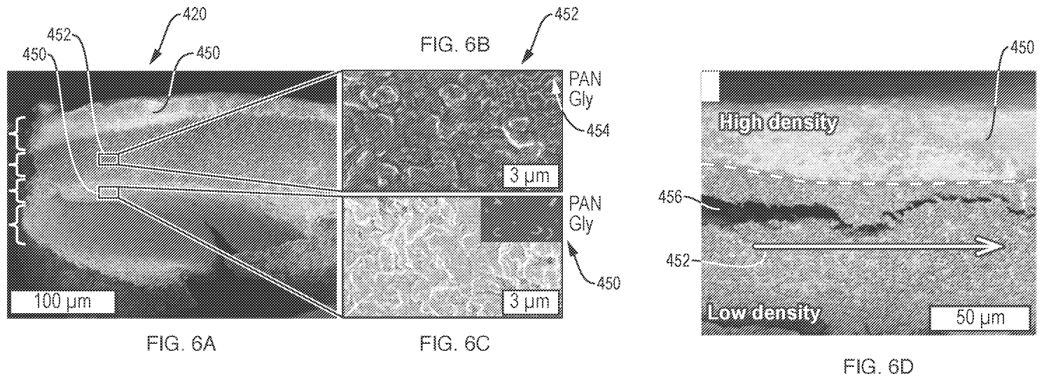

Moreover, printed polymer layers 420 can vary in structure. For example, as shown in FIGS. 6A-6D, in multilayer schemes, high density polymer layers 450 and low density polymer layers 452 can be alternated through the structure of the printed polymer layer 420, with high-density PAN layers 150 sandwiching low density layers 452 where PAN is visibly swollen with glycerol. For example, as shown in FIG. 6B, the low density layers 452 can have a connected network of glycerol pockets 454 interspersed through crevices of the polymer, while the high density layers 450 can have substantially no glycerol therein so as to form a substantially continuous polymer layer. The network of glycerol pockets 454 can weaken the structure of the polymer layer such that cracks can propagate in the weaker lower-density swollen regions while avoiding the higher-density PAN layers, as shown in FIG. 6D.

Print speed calculations can rely on polymer precipitation kinetics, which can happen through either nucleation and growth or spinodal decomposition. Experimental work with acrylonitrile shows that exposure times of about 10 seconds at a light intensity of about 50 W/m² can form a cohesive film with thickness approximately in the range of about 10 μm to about 100 μm. This speed is on-par with commercial DLP systems that rely on exposure times approximately in the range of about 5 seconds per layer to about 20 seconds per layer. Faster print speeds can be achieved, for example, by increasing the light intensity and/or the initiator concentration, although this can typically result in a decrease in the average molecular weight of the final polymer.

The concentration of reactants in the print area can be replenished sufficiently quickly. In the case of poly(acrylonitrile) (PAN), pure monomer (acrylonitrile) can be used as the organic phase, providing a theoretically infinite reservoir of this reactant. This means that the reaction zone 114 on the aqueous side 104 of the interface 102 can feature a constant acrylonitrile concentration equal to the solubility limit of acrylonitrile in water (e.g., 70 g/L or 1.3 mol/L). In that case, the question of having enough of both reactants in the reaction zone 114 can pertain to the concentration of photoinitiator. Indeed, the initial photoinitiator concentration in water (e.g., 0.037 mol/L for 1 wt. % photoinitiator) can be much lower than the monomer saturation concentration. In some embodiments, a PAN layer can be formed at the liquid-liquid interface, and its thickness T can increase with exposure time. Thickening can indicate that the reactant concentration in the reaction zone is not the limiting factor, at least up to thicknesses of tens of microns observed experimentally.

For example, while IPP is demonstrated on PAN in the present disclosure, it can be expanded to other polymer systems with certain considerations. One obstacle for using other polymer systems can be that most linear-chain polymers are soluble in their monomer due to the similarities of their chemical structures. This challenge can be overcome by adding a solvent that is both miscible with the monomer and a non-solvent for the polymer to the organic phase 102. For example, in embodiments in which a monomer that is a non-solvent for its polymer is used, such as for methyl methacrylate (MMA) or styrene, the organic phase can become a mixture of the monomer and a non-solvent for the polymer such as hexane. In this case, the transport of the monomer to the liquid-liquid interface 108 and its partitioning between the aqueous 104 and organic phase 102 can be considered. Moreover, in these particular cases, high molecular weight polymer chains can be obtained when a poor solvent was mixed with the monomer. This results in a modification of the governing coupled differential equations by adding the flux of monomer within the aqueous phase and its partitioning at the liquid-liquid interface. When computing those values for MMA, the MMA transport from the organic to the water phase can be non-limiting, with that saturation concentration being able to be reached in about 0.1 seconds. Additionally, the concentration of initiator in the aqueous phase can feature a similar evolution as in the case of acrylonitrile, thereby demonstrating that the concentration of reactants in the print area can be replenished sufficiently quickly for any of the proposed chemistry used or otherwise understood by a person skilled in the art, in view of the present disclosures, that can be used. Still further, to improve transport of reactive species to the liquid-liquid interface 108, additional printer design solutions such as stirring or slow flow of the phases can be implemented. A person skilled in the art will recognize that the criterion defined for a poor solvent is that the difference in solubility parameter between the polymer and organic phase is at least 1.8 Hildebrand (H=cal^{1/2} cm^{-3/2}) units. Other potential candidates of organic phases beyond hexane with solubility parameter differences close to 1.8H include heptane, isooctane, and octane. Additional examples of polymer systems that can be processed via IPP can include polystyrene (PS) and polymethyl methacrylate (PMMA), commodity polymers widely used in industrial and consumer products.

To the extent that various compounds, reactions, amounts, and so forth are discussed in the present disclosure, they are non-limiting and a person skilled in the art, in view of the present disclosures, will understand other variations, combinations, etc. that can be used for similar purposes.

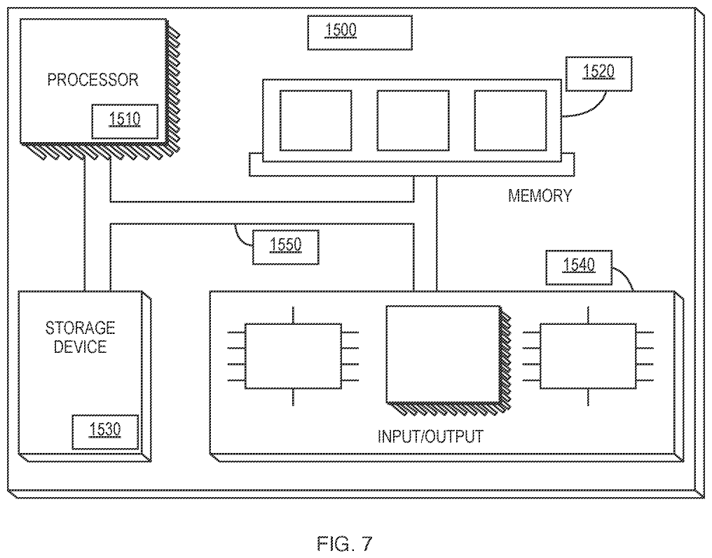

FIG. 7 is a block diagram of one exemplary embodiment of a computer system 1500 upon which the controller or control system of the computer 340 of the present disclosures can be built, performed, trained, etc. For example, any modules or systems can be examples of the system 1500 described herein. The system 1500 can include a processor 1510, a memory 1520, a storage device 1530, and an input/output device 1540. Each of the components 1510, 1520, 1530, and 1540 can be interconnected, for example, using a system bus 1550. The processor 1510 can be capable of processing instructions for execution within the system 1500. The processor 1510 can be a single-threaded processor, a multi-threaded processor, or similar device. The processor 1510 can be capable of processing instructions stored in the memory 1520 or on the storage device 1530. The processor 1510 may execute operations such as, by way of non-limiting examples, starting and stopping light delivery, control of power and motion commands that can be automatic, in response to various parameters, and/or manually controlled by a user, including in response to signals/parameters/etc., and so forth, and/or based on observation/preference, and so forth, among other features described in conjunction with the present disclosure. The controller 1500 can optimize operation in response to varying a location of the photopolymerization reaction, and other factors that can relate to the speed, density, and integrity of polymer formation. The controller 1500 may further embed machine-learning techniques, artificial intelligence, and/or digital twinning that can aid in improving performance.

The memory 1520 can store information within the system 1500. In some implementations, the memory 1520 can be a computer-readable medium. The memory 1520 can, for example, be a volatile memory unit or a non-volatile memory unit. In some implementations, the memory 1520 can store information related to fluid compositions, relative densities, light exposure times, and so forth, which can allow for a machine learning optimization of the system.

The storage device 1530 can be capable of providing mass storage for the system 1500. In some implementations, the storage device 1530 can be a non-transitory computer-readable medium. The storage device 1530 can include, for example, a hard disk device, an optical disk device, a solid-date drive, a flash drive, magnetic tape, and/or some other large capacity storage device. The storage device 1530 may alternatively be a cloud storage device, e.g., a logical storage device including multiple physical storage devices distributed on a network and accessed using a network. In some implementations, the information stored on the memory 1520 can also or instead be stored on the storage device 1530.

The input/output device 1540 can provide input/output operations for the system 1500. In some implementations, the input/output device 1540 can include one or more of network interface devices (e.g., an Ethernet card or an InfiniBand interconnect), a serial communication device (e.g., an RS-232 10 port), and/or a wireless interface device (e.g., a short-range wireless communication device, an 802.7 card, a 3G wireless modem, a 4G wireless modem, a 5G wireless modem). In some implementations, the input/output device 1540 can include driver devices configured to receive input data and send output data to other input/output devices, e.g., a keyboard, a printer, and/or display devices. In some implementations, mobile computing devices, mobile communication devices, and other devices can be used.

In some implementations, the system 1500 can be a microcontroller. A microcontroller is a device that contains multiple elements of a computer system in a single electronics package. For example, the single electronics package could contain the processor 1510, the memory 1520, the storage device 1530, and/or input/output devices 1540.

Although an example processing system has been described above, implementations of the subject matter and the functional operations described above can be implemented in other types of digital electronic circuitry, or in computer software, firmware, or hardware, including the structures disclosed in this specification and their structural equivalents, or in combinations of one or more of them. Implementations of the subject matter described in this specification can be implemented as one or more computer program products, i.e., one or more modules of computer program instructions encoded on a tangible program carrier, for example a computer-readable medium, for execution by, or to control the operation of, a fluid filtration system. The computer readable medium can be a machine-readable storage device, a machine-readable storage substrate, a memory device, a composition of matter effecting a machine-readable propagated signal, or a combination of one or more of them.

Various embodiments of the present disclosure may be implemented at least in part in any conventional computer programming language. For example, some embodiments may be implemented in a procedural programming language (e.g., “C” or ForTran95), in an object-oriented programming language (e.g., “C++”), and/or other programming languages (e.g. Java, JavaScript, PHP, Python, and/or SQL). Other embodiments may be implemented as a pre-configured, stand-along hardware element and/or as preprogrammed hardware elements (e.g., application specific integrated circuits, FPGAs, and digital signal processors), or other related components.

The term “computer system” may encompass all apparatus, devices, and machines for processing data, including, by way of non-limiting examples, a programmable processor, a computer, or multiple processors or computers. A processing system can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, executable logic, or code) can be written in any form of programming language, including compiled or interpreted languages, or declarative or procedural languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Such implementation may include a series of computer instructions fixed either on a tangible, non-transitory medium, such as a computer readable medium. The series of computer instructions can embody all or part of the functionality previously described herein with respect to the system. Computer readable media suitable for storing computer program instructions and data include all forms of non-volatile or volatile memory, media and memory devices, including by way of example semiconductor memory devices, e.g., EPROM, EEPROM, and flash memory devices; magnetic disks, e.g., internal hard disks or removable disks or magnetic tapes; magneto optical disks; and CD-ROM and DVD-ROM disks. The processor and the memory can be supplemented by, or incorporated in, special purpose logic circuitry. The components of the system can be interconnected by any form or medium of digital data communication, e.g., a communication network. Examples of communication networks include a local area network (“LAN”) and a wide area network (“WAN”), e.g., the Internet.

Those skilled in the art should appreciate that such computer instructions can be written in a number of programming languages for use with many computer architectures or operating systems. Furthermore, such instructions may be stored in any memory device, such as semiconductor, magnetic, optical, or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the present disclosure may be implemented as a combination of both software (e.g., a computer program product) and hardware. Still other embodiments of the present disclosure are implemented as entirely hardware, or entirely software.

### Examples

Some non-limiting examples of compositions, experiments, and techniques to facilitate and test the results of the presently disclosed reactions are provided for in conjunction with the present disclosures.

To facilitate the photopolymerization reaction, acrylonitrile (AN) (≥99%, can contain approximately a range of about 35 ppm to about 45 ppm monomethyl ether hydroquinone as inhibitor) can be obtained from Millipore Sigma. Acrylonitrile is a clear, colorless, or slightly yellow liquid that is highly volatile and toxic. Acrylonitrile vapor is heavier than air. AN has a pungent odor of onion or garlic that does not provide adequate warning of hazardous levels and is poisonous by inhalation, ingestion or skin contact. Within the body, AN releases cyanide. Inhibitor can be removed right before IPP synthesis by passing the AN through a custom column. The custom columns can be created by stuffing a pasteur pipette with small amount of cotton from cotton balls. The cotton can be pushed down the pipette until it occupies a height of about 1 cm on top of where the pipette diameter reduces. The cotton layer can then be covered by an about 1 cm to about 2 cm layer of glass spheres (Millipore Sigma, 150-212 μm (70-100 U.S. sieve)). AN can then be passed through multiple custom columns in parallel to remove monomethyl ether hydroquinone efficiently. The inhibitor-free AN can then be used in IPP within about 24 hours of inhibitor removal.

Other chemicals can be used without further purification. Water (suitable for HPLC, ≥99.9%), Glycerol (ACS reagent, ≥99.5%), and Acetone (suitable for HPLC, ≥99.9%) can all be obtained from Millipore Sigma. Glass ampoules of dimethyl sulfoxide-[d_6]≥99.96% (Isotopic) (MagniSolv™) for NMR spectroscopy can be obtained from Millipore Sigma. Water-soluble photoinitiators 2,2′-Azobis(2-methylpropionamidine) dihydrochloride (V-50) and 2,2′-Azobis[2-(2-imidazolin-2-yl) propane] dihydrochloride (VA-044) can be purchased from FUJIFILM Wako Pure Chemical Corporation. Commercial PAN (average Mw 150,000 Da) can be obtained from Millipore Sigma.

### Equipment, Supplies, and Chemicals

IPP-DLP single layer apparatus
Projection mask—custom-made Chromium on Quartz.
Custom build plate (optional)
A laptop or computer equipped with the Arduino editor/compiler and Pylon Viewer (camera software)
A timer or stopwatch
A smoke pencil to check the airflow into the overhead snorkel ventilation (Store in the upright position)
High-precision scale
A stir-plate
A vortex mixer

### Supplies:

20 mL amber vials with caps.
25 mL disposable serological pipettes and appropriate pipette filler
100 mL graduated cylinder
VWR Laboratory tape
Kapton tape
Disposable glass Pasteur pipettes
Cotton balls
Aluminum oxide (activated, neutral, Brockmann I)
Latex pipette bulbs
A 100 mL glass beaker
A 1-10 mL high-precision pipette and associated pipette tips
   Pipettes should never be tilted if they are containing liquid or have a used pipette tip on. This results in the liquid making its way to the body of the pipette itself, causing potential splash exposure with the measured chemical, cross-contamination, and decreased precision. Keep your pipettes in the upright position whenever in use. They can be hung on the aluminum bar frame in the back of the hood to ensure they remain upright while working.
A small beaker of arbitrary size to prevent draining of the columns on the workbench
A 50×50 mm quartz cuvette
Cuvette cover (e.g. parafilm, oversize glass slide etc.)
Ziploc bags
Crystallization dish large enough to fit the build plate.
Tweezers
Glass slides
Alconox powder detergent—Mix a small amount with tap water
Glassware cleaning swabs and brushes

### Reagents:

Acrylonitrile—≥99%, contains 35-45 ppm monomethyl ether hydroquinone as inhibitor
Photoinitiator (V-50, VA-044 and so forth)

### Solvents:

High purity deionized water (usually suitable for HPLC).

Glycerol—ACS reagent, ≥99.5%.

Isopropyl alcohol and acetone for rinsing/cleaning of the glassware.

### Mask Fabrication and Testing

Quartz projection masks can be fabricated by photolithography. For example, four inch (4″) quartz wafers (Hoya Corporation) can be first functionalized with hexamethyldisilazane (HMDS) for about 10 seconds at about 150 degrees Celsius (Yield Engineering Systems, Inc.) to improve photoresist wettability and subsequent coating uniformity. AZ 3312 positive photo resist (AZ Electronic Materials) can then be spin-coated on the functionalized wafers. The resin can be first uniformly distributed across the wafer by pipetting about 5 mL of resist onto the substrate before spinning at about 500 RPM for about 6 seconds. Evaporation and thin film can be obtained by two subsequent high-speed spinning steps for about 6 seconds at about 750 RPM and 60 seconds at about 3000 RPM. A pre-exposure bake can be performed on a hotplate at about 112 degrees Celsius for about 90 seconds. Following spin coating, the resist can be exposed using, for example, a direct-write lithography Heidelberg MLA-150 Advanced Maskless Aligner. The mask pattern can be first designed as .dxf AutoCAD file before being converted to a .gdsii file using LinkCAD software. The appropriate toolpath can be extracted from this file using the MLA 150 software and exposure can be performed using a 405 nm laser with a dose of 130 mJ cm-2. The exposed resist can then be developed by immersion and light agitation in AZ 300 MIF developer (AZ Electronic Materials) containing 0.26 N (0.283%) tetramethylammonium hydroxide (TMAH) for about 90 seconds. The masks can then be washed with deionized water and dried with compressed air. The opaque Cr layer can be deposited by sputtering (Angstrom Engineering), using a 3 inch DC sputter source at about 360 W in an Ar atmosphere. The deposition rate can be about 1.05 Å/s and can be performed under a vacuum of at least about 2×10\hat{ }-6 Torr. The wafers can then be diced and individual masks isolated as, for example, 15×15 mm square chips. Transparent area of the masks can be revealed by lift-off, immersing the wafer in acetone and bath sonicating (Crest Ultrasonics) for about 8 minutes. The final masks can then be rinsed with IPA and dried with nitrogen before being installed in the IPP optical train.

Prior to IPP, photoinitiators can be dissolved in a solution of about 37.5 vol % glycerol in water and vortex-mixed until complete dissolution. The addition of glycerol to the aqueous phase is motivated by increasing its density (1.1051 g mL⁻¹ for 37.5 vol % glycerol) and preventing sinking of the PAN film upon precipitation. Ten milliliters (10 mL) of photoinitiator solution can be first added in a customized quartz fluorescence cuvette (50 mm×50 mm×50 mm, Volume 112.5 mL-Science Outlet). Then, about 10 mL of inhibitor-free AN can be slowly poured on top to minimally disrupt the liquid-liquid interface. All IPP experiments can be conducted at maximum output optical power (of about 468 W m⁻²) for about 30 seconds exposure time.

### Operational Procedures

Ambient light conditions and warning: Whenever starting the IPP-DLP experiment, other users can be notified and “UV light form” can be updated with the duration of the experiment. Although IPP-DLP printing involves UV-reactive chemicals, most of it can be conducted in reasonable ambient light conditions (e.g. ceiling light but closed blinds, and most blackout walls of the setup enclosure being on). For short experiments (less than an hour), no difference was observed between conducting the print in ambient light or red lights. For safety, and reducing the risk of spill, the use of ambient light can be facilitated by using amber storage vials for solution storage and by having the fume hood windows covered with a UV-protective film. Do not transport the cuvette or vials between the hood and IPP-DLP setup in the dark. This may result in tripping and falling, or potential acrylonitrile spill in the lab. In the case of long prints, it is recommended to switch off ambient light and using red light after having secured the cuvette on the IPP DLP setup. Refrain from moving the cuvette on the support plate of the IPP-DLP setup in the dark or in red light conditions. The support plate can feature a hole in the center to ensure a bottom camera view. Moving the cuvette in a low-visibility context may result in the cuvette falling through the hole, the generation of a hazardous spill, and irreversible damage to the imaging optics below.

Preparation of the fume hood bench: Whenever working in the hood, it is highly recommended to cover the work area with beta wipes to mitigate any spills. Also a Ziploc bag can be added in a corner to quickly dispose of gloves, contaminated wipes, and any non-sharp hazardous waste easily and safely. At the end of the day, transfer the sealed Ziploc bag in the solid-waste pail and ensure it is labelled properly with a properly filled-out hazardous waste tag.

Preparation of the IPP-DLP setup: As the IPP-DLP setup is vibration sensitive, it has been installed outside the fume hood and can use appropriate ventilation through an overhead snorkel to avoid acrylonitrile inhalation. The projection mask can also be changed/removed and project the image at the liquid-liquid interface through a two-lens afocal system.

Image projection and optical train: In the IPP-DLP single-layer system, an image can created at the liquid-liquid interface using a UV LED as the light source, a static projection mask, and an afocal projection system equipped with two convergent lenses (f′=50 mm and 75 mm→Magnification of 1.5). Every time the liquid height is changed, or the mask is removed or swapped, collimating/refocusing the object is paramount.

Setting up the bottom-view imaging system and Arduino: To operate the camera and adjust exposure time and PWM control of the LED you will need to install the Pylon viewer software from Basler and the Arduino IDE software.

Mask placement, light collimation, and image formation: Make sure the LED is switched off and the system has been cooled down to room temperature if elongated exposure happened prior to this. Remove the LED from the setup by simply twisting it out of the 3D printed socket. Unscrew the collimation optical train (diffuser, mask, collimating lens) from the Thorlabs plate that supports it on the vertical linear rail. Keep the retaining ring on the threaded part of the lens tube, as this saves time at the refocusing step. Unscrew the top lens tube that supports the diffuser to expose the top of the mask holder (custom non-anodized aluminum lens tube). Place the mask of your choice (after appropriate lift-off and cleaning) in the square cavity, and secure with thin strips of Kapton tape on the cavity walls to avoid rotation upon collimation. Screw the diffuser lens tube back on and secure the LED using the 3D printed twist plug. Switch off the room light, switch on the LED and target the beam at the opposite wall which has a small paper screen. Adjust the distance between the collimating lens and the mask using the adjustable lens tube to obtain a sharp and clear image of the mask on the wall. Once the image is focused on the far-away wall (e.g., infinity from a ray optics perspective), tighten the retaining ring on the lens tube to fix the distance between the mask and lens. It is important to note that this can be approximately the lens focal length e.g., 50 mm, which indicates that the light is now collimated. Switch off the LED, remove it from the twist plug and secure your optical train back onto the vertical linear rail by screwing the bottom lens tube to the corresponding plate. To refocus the light at the liquid-liquid interface, fill the cuvette with the same volume of water that you will use for your bottom phase in IPP-DLP (typically 10 mL if no build plate is used and 20 mL if you will use the build plate) and place it in the light path, on the support plate. Uncover the Macro lens used for bottom-view imaging and turn on the camera by plugging it in the appropriate computer and opening the Pylon imaging software. Switch on the UV light source and place a piece of optical paper floating onto the water in the cuvette. Now, focus the camera onto the liquid-air interface using the macro lens manual control rings. To do the camera exposure time can be lowered to its minimum to not saturate the CCD detector with UV light. It will be in focus because the fibrous texture of the optical paper on the camera can be seen. Remove the piece of paper and form a clear and sharp image of the mask at the liquid-air interface by adjusting (1) the position distance between the focusing lens and the collimating lens by loosening the set screw on the supporting lens plate and translating it up and down the vertical rail, and (2) the distance between the focusing lens the liquid-liquid interface using the manual translational stage on the back of the optical train. Verify that an image magnification of about 1.5 compared to the mask size exists. This indicates that the projection optical train is now fully aligned and calibrated. Additionally, the lens-to-lens distance should be approximately equal to the sum of their focal lengths. Moreover, if the volume of liquid during processing is changed, do not touch the lens-to-lens distance. Rather, adjust the height of the entire optical train using the vertical Vernier. Further still, minimal distance adjustment may be performed if the mask is changed and the position of the retaining rings and lens plate is not disturbed.

Ensuring proper ventilation: The snorkel can be used to draw vapors in before starting any IPP-DLP experiment. Without this, workers can inhale acrylonitrile, show CNS symptoms, and require immediate medical care. To do so, place the snorkel at the front of the optical enclosure, with the magnetic blackout wall removed. The snorkel can be rotated, and have it as close to the cuvette position as possible (plastic cover touching the 80-20 of the enclosure). Visualize the airflow of vapor into the snorkel using the smoke pencil and placing it where the cuvette will be. The smoke can be drawn directly in the duct, with no leakage around the spherical plastic cover. Adjust the snorkel position until this is the case and check ventilation regularly while working. Place a new, open Ziploc bag near the setup such that it is in the flow path of the snorkel. A small piece of fringed paper can be taped to the snorkel duct entrance to check for airflow and immediately notice if the ventilation has been turned off. Regularly check that the fringes are being sucked into the snorkel. If they appear static, do not begin work.

### Preparing Glycerol/Water Mixture

A mixture of 62.5 vol. % water/37.5 vol. % glycerol can be prepared. Using a disposable 25 mL serological pipette equipped with a pipet filler, measure 75 mL of glycerol (3 times 25 mL) and add to the glass bottle, equipped with a magnetic stir bar. Then, using a graduated cylinder, measure 125 mL of water (100 mL+25 mL). Add to the bottle. Place on a stir-plate for 10 minutes to ensure complete mixing. Dispose of the disposable serological pipette in the solid waste pail. Leave graduated cylinder aside and watch with the rest of the glassware at the cleanup stage.

### Preparing Initiator Solution

Switch on the high precision scale and let it zero. Grab an empty amber glass vial and place it on the high-precision scale, tare. Add the desired amount of photoinitiator to obtain 10-20 mL of initiator solution with water/glycerol (10 mL for printing without the build plate, 20 mL to print with the build plate). Add the desired volume of water/glycerol solution. Vortex mix until complete dissolution.

Removing Inhibitor from Acrylonitrile

To mitigate spontaneous polymerization of acrylonitrile during transport and storage, the monomer comes with a small fraction of inhibitor (usually 35-45 ppm monomethyl ether hydroquinone) which prevents the generation of free radicals and uncontrolled chain initiation and propagation. Removing inhibitor from the acrylonitrile monomer can ensure proper polymerization during the printing process. This is achieved by passing the monomer solution through a custom-made disposable column.

Column preparation: Plug a glass Pasteur pipette with cotton using a small stainless-steel capillary. Pack the cotton as far down in the pipette as possible. This will involve unraveling the cotton ball and pushing small pieces down, which should result in a cotton plug of about 15 mm in height. Take 7 plugged pipettes you prepared this way and tape them all together using VWR laboratory tape. Clamp the 7-pipette bundle inside the hood using a talon clamp, at least 25 cm inside the hood. F ill each plugged pipette with aluminum oxide (activated, neutral, Brockmann I) using a disposable spatula: a height of aluminum oxide of about 30 mm on top of the cotton plug can be formed.

Inhibitor removal: While wearing a lab coat, two layers of chloroprene gloves covering the coat knit cuffs to protect any exposed skin, and well-fitted safety glasses, take the acrylonitrile bottle out of the flammable cabinet and immediately bring into the hood. Grab a new, clean Pasteur pipette and equip it of a latex pipette bulb. Place a 100 ml beaker on top of a betawipe, under the column bundle. Gradually add acrylonitrile to all columns, using the diameter reduction as the top of plugged pipettes as your filling line. The monomer will flow through the columns, and the inhibitor will adsorb onto the aluminum oxide particles. Inhibitor-free acrylonitrile is collected in the beaker underneath the columns.

Inhibitor-free acrylonitrile can be stored in amber vials in the darkness of a flammable cabinet up to 2 weeks without noticing significant changes in polymer formation and properties. 10-20 mL of acrylonitrile per experiment can be used, so plan the amount of inhibitor-free monomer used accordingly. After a while, the top of the alumina layer can turn slightly brown. This is normal and is due to adsorption of the inhibitor that is separated from the monomer.

Once you have obtained the desired amount of inhibitor-free monomer, place a clean empty beaker under the column bundle to enable draining and drying of the columns before disposing of them as chemical sharps. Dispose of the pipette used to fill the columns with the latex bulb in the sharp container and ensure proper labelling of the contaminants and hazards. Fill the appropriate number of 20 mL amber vials with 10 mL of inhibitor-free acrylonitrile using a large precision pipette (1-10 mL). The 10-mL volume limit imposed here is to prevent spilling of acrylonitrile through the vial cap in case it is tilted or knocked now. Properly cap, label, and date all your vials. As an extra precaution, you can wrap parafilm around each vial caps. Store the vials in the upright position in a nearby flammable cabinet.

### IPP Printing

Set-up: Bring the cuvette (optionally with the build plate attached) to the IPP DLP setup and place onto the supporting plate in the light path. The position of the cuvette can be adjusted on its support using the in-plane Verniers at the base of the dedicated optical rail. Double check that the snorkel provides enough draw to capture evaporation from the cuvette and your disposal Ziploc bag for chemical waste. Pour the aqueous initiator solution and dispose of the vial(s) into to Ziploc bag. Carefully pour inhibitor-free acrylonitrile on top and dispose of the vial in the waste Ziploc bag. If the build plate is being used for multilayer printing, use the Vernier to bring it up as close to the liquid-liquid interface as possible. If the build plate will be used for single-layer retrieval, it can be left at the bottom of the cuvette for printing.

Dummy print: Start the experiment with a long-exposure “dummy print” to allow for PAN to saturate the aqueous phase and obtain fast subsequent printing through precipitation. To do so, put a corner of the cuvette in the light path, switch on the UV LED and expose until you obtain a large polymer film which is the size of the exposed area (˜10 min, depending on the photoinitiator concentration). A large amount of degassing will be observed; this is normal and is due to the photoinitiator releasing nitrogen upon activation.

Subsequent prints: After the dummy print has been performed, move to a clear area of the cuvette (fairly centered on the build plate if you are using it). To do so, the cuvette can be moved directly, or use the X-Y linear stages under the cuvette support assembly. Wait about 8-12 min for the liquid-liquid interface to stabilize before exposing. If performing in-plane resolution tests, take a bottom view image with the UV light off (or a piece of black paper in the optical path onto the focusing lens) and ambient light on, immediately after finishing exposure. Do not wait or the image will become distorted as the film is simply floating at the liquid-liquid interface.

For multilayer manual printing: lower the build plate gradually. Additionally, make sure the cuvette does not move on the supporting plate. Otherwise, this will result in misalignment every time you rotate the Vernier because it will move the cuvette with it.

### Film Isolation and Pickup (Optional)

If using the manual build plate and want to recover the printed films or if you just performed a manual multilayer printing, retrieve the film for further analysis. This is where most of the hazard for this procedure resides, along with clean-up. So please read thoroughly. First, remove as much excess liquid as possible. Grab a glass Pasteur pipette equipped with a bulb and a small sealable bottle. Slowly pipette out as much of the top and bottom phase as you can. In the case where the build plate as a pick-up device for a single layer is used, get the film close to the plate and eliminate as much of the acrylonitrile possible. Then, slowly raise the build plate out of the remaining liquid using the Vernier, as shown in FIG. 5. In the case of single-layer film pickup, if the film is slipping in one direction, slow down or tilt the cuvette slightly to prevent stretching. Seal the waste bottle and bring it to the fume hood. Put the pipette in your waste Ziploc bag at the IPP DLP setup and do not forget to separate it from other solid waste and put it in the sharp container at clean-up. Cover the cuvette (still equipped with the build plate, but above the liquid level) with a lid (can be parafilm or an oversized glass slide) and walk the whole assembly to the fume hood slowly. In the hood, remove the bracket from the cuvette, and untighten the build plate shaft collar. Pour deionized water in a small crystallization dish and very slowly dip the build plate in it for rinsing. Stay close to the water surface to avoid liftoff. At this step, it is fairly easy to remove the dummy print if single layer printing by pushing it out of the water using a clean pair of tweezers. Take out of the water and lay on beta wipes to let the excess water drain. Then, remove paper clips and lay the filter paper on a glass slide. The film can be to dry. Drying will most likely induce shrinkage and cracking of the film. To eliminate the residual glycerol, rinse with isopropyl alcohol or acetone. However, faster solvent evaporation will induce additional cracking in the polymer. This is a tradeoff to work out for future printing.

### Clean-Up

Dispose of all solvent waste (from the small bottle used for removing excess phase as well as rinsing deionized (DI) water and liquid left in the cuvette) in its own IPP-DLP waste stream and properly filled in the hazardous waste red tag. Thoroughly rinse all glassware with isopropyl alcohol, water and acetone and dispose of the rinsing liquid in the same hazardous waste stream. Then glassware can be brought to the sink for further cleaning. Open the warm water tap and with brush and swab, thoroughly clean any residue using alconox and tap water. Rinse with warm water. Rinse with tap DI water. Leave to air dry or place in drying oven in the hallway. Dispose of pasteur pipettes in the sharp container in the hood and fill in the hazardous red tag. Seal solid waste Ziploc bags (gloves, wipes etc.), place in the solid waste pail and ensure proper reporting on the hazardous waste tag. Wipe down the hood workspace with acetone and dispose of the wipe in the solid waste pail.

Examples of the above-described embodiments can include the following:

1. A method for fabricating a polymer object, comprising:
forming an immiscible liquid-liquid interface with a first liquid comprising at least a first monomer and a second liquid comprising at least a photoinitiator; and
irradiating the immiscible liquid-liquid interface with light to cause at least the photoinitiator to react with the first monomer in a reaction zone proximate to the immiscible liquid-liquid interface to form a first film.
   2. The method of example 1, wherein the polymer object comprises one or more of a linear chain polymer, a thermoset, or a thermoplastic.
   3. The method of example 1 or example 2, further comprising positioning a build plate at or proximate to the liquid-liquid interface such that the first film is formed thereon.
   4. The method of any of examples 1 to 3, further comprising adjusting a height of the liquid-liquid interface after the first film is formed.
   5. The method of example 4, wherein adjusting a height of the liquid-liquid interface further comprises adjusting a position of the build plate relative to the liquid-liquid interface.
   6. The method of example 5, wherein adjusting the position of the build plate further comprises lowering the build plate at discrete intervals to maintain a solid-free reaction zone for formation of at least a second film.
   7. The method of example 5, wherein adjusting the position of the build plate further comprises lowering the build plate at least one of substantially continuously, at a constant velocity, or at a changing velocity to maintain a solid-free reaction zone for formation of at least a second film.
   8. The method of any of examples 1 to 7, wherein the second film is added to the first film such that the first film and the second film form a single contiguous object.
   9. The method of example 8, wherein the polymer object is formed by physical entanglement of newly formed polymer in the second film with previously formed polymer in the first film.
   10. The method of any of examples 1 to 9, further comprising controlling one or more parameters of the reaction of the photoinitiator with the first monomer, the one or more parameters comprising one or more of a nature of the two liquid phases, a light focal point on or near the liquid-liquid interface, a shape of an image projected, an exposure wavelength, intensity, or time, or the comparison of the formed film position to a build plan or to an image focal plane.
   11. The method of any of examples 1 to 10, wherein a reactive species in the first liquid has sufficient affinity with a second liquid to partition in the second liquid and react with a complementary reactant dissolved in the second liquid.
   12. A method for fabricating a polymer layer, comprising:
forming an immiscible liquid-liquid interface with a first liquid comprising at least a first monomer and a second liquid comprising at least a photoinitiator; and
irradiating the immiscible liquid-liquid interface with light to cause at least the photoinitiator to react with the first monomer in a reaction zone proximate to the immiscible liquid-liquid interface to form at least a first film of the polymer layer.
   13. The method of example 12, wherein the light is projected onto the liquid-liquid interface through a mask image.
   14. The method of example 13, wherein the first film of the polymer layer has the structure of the mask image.
   15. The method of any of examples 12 to 14, wherein the first liquid comprises one or more of acrylonitrile (AN), polyacrylonitrile (PAN), styrene, polystyrene, methylmethacrylate, or polymethylmethacrylate (PMMA).
   16. The method of any of examples 12 to 15, wherein the second liquid comprises a water-soluble photoinitiator dissolved in an aqueous solution.
   17. The method of any of examples 12 to 16, wherein the second liquid further comprises an antisolvent, the antisolvent comprising one or more of hexane, heptane, octane, or isooctane.
   18. The method of any of examples 12 to 17, wherein a depth of the reaction zone defines an upper limit of a thickness of the first film.
   19. The method of any of examples 12 to 18, further comprising spatially adjusting a location of the light relative to the liquid-liquid interface to focus the light in a desired spatial distribution on the interface or on the reaction zone.
   20. The method of any of examples 12 to 19, further comprising adjusting a height of a build plate positioned at the liquid-liquid interface in response to a controller that controls one or more of activation of the light, position of the light, or outflow of the first liquid or the second liquid from a vessel in which the liquids are contained.

One skilled in the art will appreciate further features and advantages of the disclosures based on the provided for descriptions and embodiments. Accordingly, the inventions are not to be limited by what has been particularly shown and described. All publications and references cited herein are expressly incorporated herein by reference in their entirety.

What is claimed is:

1. A method for fabricating a polymer object, comprising:
forming an immiscible liquid-liquid interface with a first liquid comprising at least a first monomer and a second liquid comprising at least a photoinitiator; and
irradiating the immiscible liquid-liquid interface with light to cause at least the photoinitiator to react with the first monomer in a reaction zone proximate to the immiscible liquid-liquid interface to form a first film.

2. The method of claim 1, wherein the polymer object comprises one or more of a linear chain polymer, a thermoset, or a thermoplastic.

3. The method of claim 1, further comprising positioning a build plate at or proximate to the liquid-liquid interface such that the first film is formed thereon.

4. The method of claim 1, further comprising adjusting a height of the liquid-liquid interface after the first film is formed.

5. The method of claim 3, wherein adjusting a height of the liquid-liquid interface further comprises adjusting a position of the build plate relative to the liquid-liquid interface.

6. The method of claim 4, wherein adjusting the position of the build plate further comprises lowering the build plate at discrete intervals to maintain a solid-free reaction zone for formation of at least a second film.

7. The method of claim 4, wherein adjusting the position of the build plate further comprises lowering the build plate at least one of substantially continuously, at a constant velocity, or at a changing velocity to maintain a solid-free reaction zone for formation of at least a second film.

8. The method of claim 1, wherein the second film is added to the first film such that the first film and the second film form a single contiguous object.

9. The method of claim 8, wherein the polymer object is formed by physical entanglement of newly formed polymer in the second film with previously formed polymer in the first film.

10. The method of claim 1, further comprising controlling one or more parameters of the reaction of the photoinitiator with the first monomer, the one or more parameters comprising one or more of a nature of the two liquid phases, a light focal point on or near the liquid-liquid interface, a shape of an image projected, an exposure wavelength, intensity, or time, or the comparison of the formed film position to a build plan or to an image focal plane.

11. The method of claim 1, wherein a reactive species in the first liquid has sufficient affinity with a second liquid to partition in the second liquid and react with a complementary reactant dissolved in the second liquid.

12. A method for fabricating a polymer layer, comprising:
forming an immiscible liquid-liquid interface with a first liquid comprising at least a first monomer and a second liquid comprising at least a photoinitiator; and
irradiating the immiscible liquid-liquid interface with light to cause at least the photoinitiator to react with the first monomer in a reaction zone proximate to the immiscible liquid-liquid interface to form at least a first film of the polymer layer.

13. The method of claim 11, wherein the light is projected onto the liquid-liquid interface through a mask image.

14. The method of claim 12, wherein the first film of the polymer layer has the structure of the mask image.

15. The method of claim 11, wherein the first liquid comprises one or more of acrylonitrile (AN), polyacrylonitrile (PAN), styrene, polystyrene, methylmethacrylate, or polymethylmethacrylate (PMMA).

16. The method of claim 11, wherein the second liquid comprises a water-soluble photoinitiator dissolved in an aqueous solution.

17. The method of claim 11, wherein the second liquid further comprises an antisolvent, the antisolvent comprising one or more of hexane, heptane, octane, or isooctane.

18. The method of claim 11, wherein a depth of the reaction zone defines an upper limit of a thickness of the first film.

19. The method of claim 11, further comprising spatially adjusting a location of the light relative to the liquid-liquid interface to focus the light in a desired spatial distribution on the interface or on the reaction zone.

20. The method of claim 11, further comprising adjusting a height of a build plate positioned at the liquid-liquid interface in response to a controller that controls one or more of activation of the light, position of the light, or outflow of the first liquid or the second liquid from a vessel in which the liquids are contained.
